(19) United States
(12) Patent Application Publication
(10) Pub. No.: US 2025/0317265 A1
(43) Pub. Date: Oct. 9, 2025

(54) SYSTEMS, METHODS, AND DEVICES FOR SUB-BAND FULL-DUPLEX (SBFD) COMMUNICATIONS

(71) Applicant: Apple Inc., Cupertino, CA (US)

(72) Inventors: Haitong SUN, Saratoga, CA (US); Dawei ZHANG, Saratoga, CA (US); Wei ZENG, Saratoga, CA (US); Seyed Ali Akbar FAKOORIAN, San Diego, CA (US); Jie CUI, San Jose, CA (US); Ankit BHAMRI, Haar (DE); Oghenekome OTERI, San Diego, CA (US)

(21) Appl. No.: 19/171,040

(22) Filed: Apr. 4, 2025

Related U.S. Application Data
(60) Provisional application No. 63/575,584, filed on Apr. 5, 2024.

(51) Int. Cl. H04L 5/14; H04L 5/00; H04W 72/0453

(52) U.S. Cl. CPC H04L 5/14; H04L 5/0007; H04L 5/0044; H04W 72/0453

(57) ABSTRACT

The techniques herein include solutions for enabling a user equipment (UE) and a base station to communicate via sub-band full-duplex (SBFD). A UE may receive, from a base station, resource allocation information for SBFD communications. The information may include downlink (DL) and/or uplink (UL) channel resources that overlap, in a frequency domain, with sub-bands associated with the SBFD communications. The UE may generate UL information to be communicated to the base station and engage in SBFD communication by: transmitting, via the UL channel resources that overlap in the frequency domain with the UL sub-band, the UL information as part of the SBFD communications; and receiving, via the DL channel resources that overlap with the DL sub-band, DL information as part of the SBFD communications. Many other aspects and examples of the techniques are also described herein.

### CROSS-REFERENCE TO RELATED APPLICATIONS

This application claims the benefit of U.S. Provisional Application No. 63/575,584, filed Apr. 5, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. One of many aspects of developing such technologies includes determining how resources are allocated for different wireless communication scenarios.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example process for sub-band full-duplex (SBFD) communications according to one or more implementations described herein.

FIG. 4 is a diagram of an example for SBFD communications when sub-bands overlap with physical resource blocks (PRBs) of a physical downlink (DL) shared channel (PDSCH) and a physical uplink (UL) shared channel (PUSCH) according to one or more implementations described herein.

FIG. 5 is a diagram of an example for SBFD communications when a sub-band partially overlaps with resource block groups (RBGs) of a PUSCH according to one or more implementations described herein.

FIG. 6 is a diagram of an example for SBFD communications when a sub-band partially overlaps with RBGs of a PDSCH according to one or more implementations described herein.

FIG. 7 is a diagram of an example for SBFD communications when SBFD symbols overlap with PDSCH symbols according to one or more implementations described herein.

FIG. 8 is a diagram of an example for SBFD communications when a sub-band partially overlaps with PRBs of a PDSCH with slot aggregation according to one or more implementations described herein.

FIG. 9 is a diagram of an example for SBFD communications when channel state information (CSI) measurements are performed for sub-bands of the SBFD communications according to one or more implementations described herein.

FIG. 10 is a diagram of an example for SBFD communications when a DL sub-band partially overlaps with a PRB of a code-division multiplexing (CDM) group of a PDSCH demodulation reference signals (DMRS) according to one or more implementations described herein.

FIG. 11 is a diagram of an example process for SBFD communications according to one or more implementations described herein.

FIG. 12 is a diagram of an example process for SBFD communications according to one or more implementations described herein.

FIG. 13 is a diagram of an example of components of a device according to one or more implementations described herein.

FIG. 14 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include determining how resources are allocated for different wireless communication scenarios.

A downlink (DL) communication may include a communication from a base station (or another type of network access node) to UE. An uplink (UL) communication may include a wireless transmission from a UE to a base station (or another type of network access node). DL and UL communications may involve transmissions made using frequency resources and time resources, such that transmissions are made using certain frequencies and at certain times. Doing so enables wireless communications to utilize resources in an organized and efficient manner.

Data channels, control channels, and reference signals may be used to enable communications between user equipment (UE) and base stations. Data channels, such as a physical DL shared channel (PDSCH) or a physical UL shared channel (PUSCH), may be used to carry user data, including voice calls, video streams, and internet traffic. Control channels, such as a physical DL control channel (PDCCH) or a physical UL control channel (PUCCH), may be used to manage communications by conveying control information, such as signaling messages, synchronization signals, and resource allocation commands. A PDCCH may be used for DL control signaling, while a PUCCH may handle UL control signaling.

Reference signals may be used for various purposes, such as synchronization, channel estimation, and beamforming. A PDSCH may assist in DL channel estimation and data demodulation, whereas a PUSCH may aid in UL channel estimation and power control. These components may collectively form the backbone of communication in cellular networks, supporting high data rates, low latency, and efficient resource utilization for diverse applications and services.

Wireless resources may be allocated via a grant procedure. Physical resources for transmission may be organized in a resource grid, which may include a matrix of time-frequency resource elements (REs). A base station may use the grid, or another mechanism, to allocate resources to UEs for both DL and UL communications. A grant procedure may include a process by which a base station assigns or configures wireless resources for communications between the base station and a UE. The UE may send a request to the base station for DL and/or UL resources. The base station may allocate resources to the UE based on one or more factors (e.g., network conditions, UE capabilities, etc.). The UE may receive the grant from the base station; and the UE and base station may communicate in accordance with the granted resources.

A resource grant may include one or more parameters or characteristics, such as time, frequency, modulation and coding scheme (MCS), resource allocation type, and/or power control. Time may refer to when the UE is to transmit or receive data, defined in terms of a starting transmission time and an ending transmission time. Frequency may refer to frequency resources that the UE may use to send or receive a transmission. MCS may refer to a modulation and coding rate for a transmission. Resource allocation type may refer to whether the resource allocation is localized (e.g., specific to certain resource blocks) or distributed (e.g., spread across multiple resource blocks). Power control may refer to a transmission power level to help the UE to ensure that an acceptable signal quality is maintained.

A resource grant may also include parameters for beamforming and multiple-input multiple-output (MIMO) communications. Examples of such parameters may include information relating to beamforming vectors, precoding matrices, antenna configurations to optimize the spatial domain for transmission and reception, and more. In some scenarios, resources may be granted dynamically, which may be referred to as a dynamic grant. A dynamic grant may involve a base station configuring and reconfiguring resource grants according to real-time network conditions, traffic loads, interference levels, and quality of service (QOS) requirements, and more. Dynamic grants may help ensure optimal utilization of resources and efficient communication.

A resource grant may correspond to a resource allocation type. The resource grant type may be indicated by DL control information (DCI) associated with the resource grant. A type 0 allocation may involve consecutive physical resource blocks (PRBs) being granted as a resource block group (RBG). A PRB may consist of a specific number of subcarriers in the frequency domain. PDSCH resources and/or PUSCH resources may be allocated in terms of RBGs. The RBGs may or may not be consecutive, and the number of PRBs in an RBG may vary depending on a bandwidth part (BWP) size and configuration type. A bitmap in DCI may be used to indicate the RBGs that carry PDSCH or PUSCH data. A type 1 allocation may involve consecutive RBs of a specified BWP being allocated using a starting PRB parameter and a number of PRBs parameter. DCI for type 1 allocations may include a resource indicator value (RIV) associated with a corresponding set of parameters for the allocation (e.g., the starting PRB and the number of PRBs).

DL and UL communications may be full-duplex (FD) communications or half-duplex (HD) communications. In a full-duplex scenario, a device may use different frequencies (or carriers) for simultaneous DL and UL communications. In a half-duplex scenario, DL and UL communications may be separated in time, regardless of whether the same or different frequencies or carriers are used. Technologies like frequency division duplex (FDD) or time division duplex (TDD) facilitate this capability by allocating separate frequency bands or time slots for UL and DL transmissions. Advanced antenna techniques such as beamforming further optimize signal strength and reduce interference, enhancing the efficiency of full-duplex communication.

During full-duplex communication, both UEs and base stations may participate in simultaneous transmission and reception. The base station, acting as a central node, may manage communication with multiple UEs within its coverage area. When a UE initiates communication, the UE may transmit data to the base station while simultaneously receiving data from the base station. Similarly, the base station may send data to the UE while simultaneously receiving data from the UE (or multiple UEs).

Paired spectrum communications may refer to the allocation of separate frequency bands for UL and DL transmissions, as in the case of FDD. Each frequency band may be paired with one or more other frequency bands, which may help ensure that the UL and DL transmissions do not interfere with each other. Unpaired spectrum communications may involve the use of a single frequency band or channel for both UL and DL transmissions, as in the case of TDD. In TDD, the same frequency band may be shared for UL and DL transmissions, with the UE and base station alternating between transmission and reception during different time intervals.

Sub-band full-duplex (SBFD) communication may be described as a variant of full-duplex communication. In SBFD, a frequency band may be divided into sub-bands used for simultaneous transmission and reception within the same frequency band. SBFD may enhance spectral efficiency and resource utilization, especially in environments where allocating separate frequency bands for UL and DL communication is challenging. By leveraging sub-bands, SBFD may mitigate interference and enable more efficient use of available spectrum, leading to improved network performance and capacity.

A symbol may include a basic unit of data transmission or modulation involving a specified period of time. Time resources may be arranged into slots that each include a set of symbols. Symbols may be integral to SBFD communication, enabling simultaneous transmission and reception within the same frequency band. Within SBFD, the frequency band may be divided into sub-bands, each containing a subset of subcarriers. Symbols may then be modulated onto these subcarriers within the sub-bands. For instance, in an SBFD system employing quadrature amplitude modulation (QAM), each symbol may embody a combination of amplitude and phase information, allowing for the transmission of multiple bits of data. These symbols may be allocated to subcarriers within the sub-bands, with careful attention to the spatial separation of UL and DL transmissions to minimize interference. This simultaneous transmission and reception of symbols within the same frequency band may facilitate bidirectional communication in SBFD systems.

Signal processing techniques, like beamforming and interference cancellation, may be utilized to manage interference and optimize symbol detection in SBFD communication. By allocating and employing symbols within sub-bands, SBFD communications may achieve high spectral efficiency and enable seamless two-way communication over a wireless channel. However, currently available technologies fail to provide any, or adequate solutions for enabling SBFD communications in a manner that is organized, efficient, and reliable. For example, currently available technologies fail to provide organized and reliable solutions for allocating channel resources (e.g., PRBs, RBGs, etc.) to the sub-bands of a SBFD communication.

One or more techniques described herein provide solutions for enabling SBFD communications in an organized, efficient, and reliable manner. Some of these techniques may involve solutions for applying channel resources to sub-bands associated with SBFD communications. The channel resources used for SBFD may fully overlap or partially overlap with SBFD sub-bands. The channel resources may correspond to data channels (e.g., a PDSCH or a PUSCH) or control channels (e.g., a PDCCH or a PUCCH). The techniques described herein may also enable SBFD communications involving channels statement information (CSI) and reference signals.

One or more of the techniques described herein may involve transport blocks (TBs), in addition to symbols, PRBs or RBGs. A TB may include a data unit utilized to convey user data and control information between the base station and UE. A TB may consist of encoded data bits, including payload data and control information such as error correction codes and modulation scheme indicators. The size and configuration of a TB may vary depending on factors such as channel conditions, modulation scheme, and system parameters.

A TB may be mapped onto one or more PRBs during transmission. As mentioned above, a PRB may represent a collection of subcarriers within the frequency domain and a duration of time within the time domain. The allocation of PRBs to TBs many enable efficient utilization of available bandwidth and time resources. TBs may also be mapped or allocated to RBGs, allowing for the simultaneous transmission of multiple TBs within the same frequency band. This grouping may further enhance spectral efficiency and resource utilization, contributing to improved network performance and capacity.

One or more of the techniques described herein may involve enabling SBFD communications that include control channel elements (CCEs). A CCE may be allocated within the frequency domain and time domain of a PDCCH and may include a certain number of resource element groups (REGs). A CCE may be used to convey control information such as scheduling assignments, hybrid automatic repeat request (HARQ) feedback, power control commands, and other signaling messages from a base station.

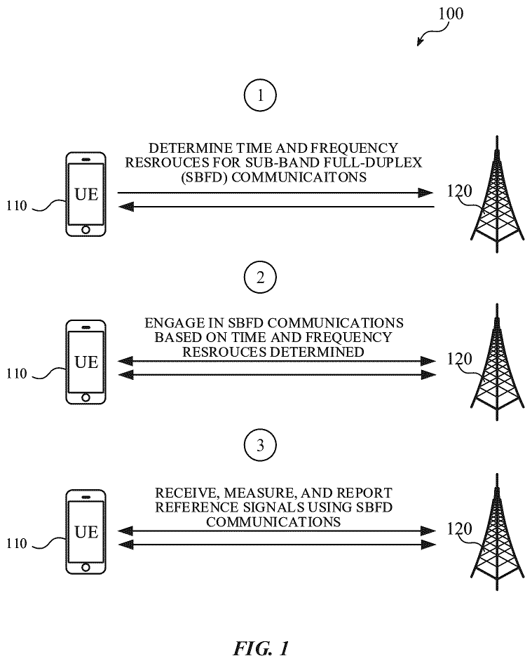

FIG. 1 is a diagram of an example of an overview 100 according to one or more implementations described herein. As shown, overview 100 may include UE 110 and base station 120. UE 110 and base station 120 may communicate with one another to determine time and frequency resources for SBFD communications (also referred to herein as SBFD resources) (at 1). Determining time and frequency resources for SBFD communications may involve determining one or more DL sub-bands and UL sub-bands for SBFD communications; determining DL channel resources and UL channel resources; determining whether/how the DL and UL channel resources overlap with the DL and UL sub-bands; and determining the SBFD resources by applying a rule to the overlapping resources.

In some implementations, the SBFD resources in the frequency domain may be limited to channel resources that fully (or completely) overlap with sub-band resources. In such a scenario, channel resources that only partially overlap with sub-band resources and channel resources that do not overlap with sub-band resources at all are not identified as SBFD resources. In another example, the SBFD resources may include channel resources that fully overlap and channel resources that partially overlap with sub-band resources. For example, a channel resource may include several contiguous RBGs that each comprises a set of contiguous PRBs. One of the RBGs may only partially overlap with a sub-band by having only some PRBs, of the partially overlapping RBG, being within a frequency range of the sub-band. In such a scenario, the overlapping PRBs, of the partially overlapping RBG, along with any fully overlapping RBGs, may be identified as SBFD resources. The techniques described herein include many also address channel resources that overlap in a time domain with sub-band resource (e.g., overlapping symbols of a slot) as well as other scenarios.

UE 110 and base station 222 may engage in SBFD communications based on the time and frequency resources determined (at 2). The SBFD communications may include any communication that involves the transmission of a UL signal and the reception of a DL signal occurring at a particular device simultaneously. SBFD communications, therefore, may include a combination of different DL and UL channels, such as a PDSCH. PUSCH, PDCCH, PUCCH, and more. UE 110 and base station 222 may also receive, measure, and report reference signals using SBFD communications (at 3). This may include signaling relating to channel state information (CSI), demodulation reference signals (DMRS), code-division multiplexing (CDM) groups, subcarriers, and more. These and other features, are described in additional detail with reference to remaining Figures.

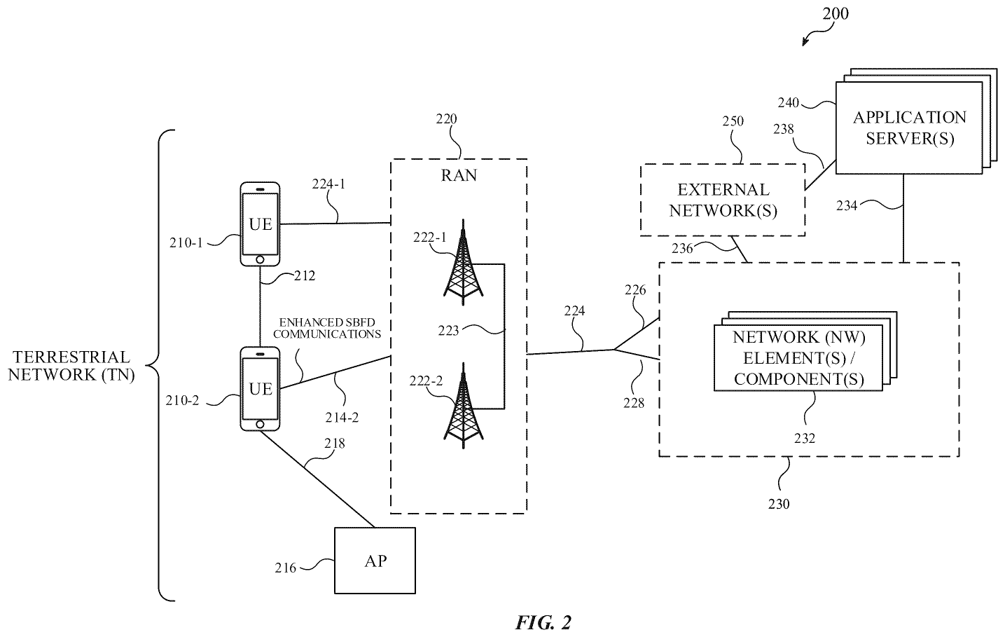

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may include a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block may comprise a collection of resource elements; in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques described herein may enable SBFD communications between UE 210 and base station 222. UE 210 1300 may receive from base station 222, resource allocation information (e.g., a resource grant) that may include DL channel resources and/or UL channel resources that overlap, in a frequency domain and/or a time domain, with sub-bands associated with SBFD communications. UE 210 may generate UL information to be communicated to the base station and engage in SBFD communication by: transmitting, via the UL information using the UL channel resources that overlap in the frequency domain with the UL sub-band; and receiving, via the DL channel resources that overlap with the DL sub-band, DL information from the base station. The DL channel may include a PDSCH or a PUSCH. The UL channel may include a PUSCH or a PUCCH. The techniques described herein may also apply to SBFD communications that involve reference signal measurement and reporting, as well as many different types of REs. Many other aspects and examples are also described herein.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

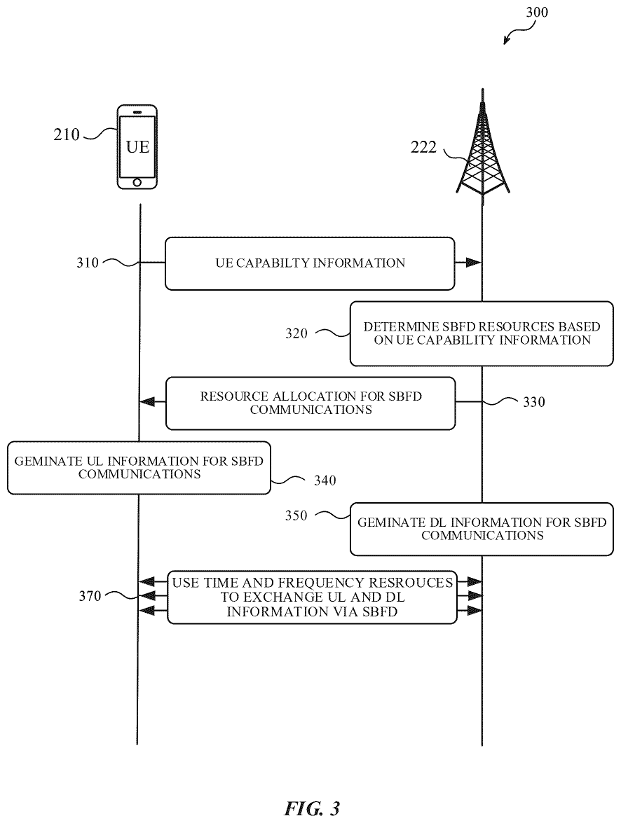

FIG. 3 is a diagram of an example process 300 for SBFD communications according to one or more implementations described herein. Process 300 may be implemented by UE 210 and one or more base stations 222. In some implementations, some or all of process 300 may be performed by one or more other systems or devices, including one or more of the devices of FIG. 2. Additionally, process 300 may include one or more fewer, additional, differently ordered and/or arranged operations than those shown in FIG. 3. In some implementations, some or all of the operations of process 300 may be performed independently, successively, simultaneously, etc., of one or more of the other operations of process 300. As such, the techniques described herein are not limited to a number, sequence, arrangement, timing, etc., of the operations or processes depicted in FIG. 3.

UE 110 may send UE capability information to base station 120 (at 310). Base station 120 may determine a resource allocation information for SBFD communications between UE 210 and base station 222 based on the UE capability information (at 320). The resource allocation information may include time and frequency resources to be used for SBFD. The resource allocation information may include DL channel resources and/or UL channel resources that fully overlap or that partially overlap, in a frequency domain and/or a time domain, with DL and UL sub-bands associated with the SBFD communications. Base station 120 may communicate the resource allocation information to UE 110 (at 330). UE 210 and base station 120 may also exchange additional, or alternative, types of information to enable SBFD communications between UE 210 and base station 222.

UE 110 may generate UL information to be communicated to base station 120 (at 340), and base station 120 may generate DL information to be communicated to UE 110 (at 350). UE 120 and base station 120 may engage in SBFD communication by simultaneously exchanging the UL and DL information (at 30) via the time and frequency resources indicated (directly and/or indirectly) by the resource allocation information.

The time and frequency resources used for SBFD communication may include UL channel resources that overlap, in the frequency domain (or time domain), with a UL sub-band associated with SBFD. The time and frequency resources used for SBFD communication may also, or alternatively, include DL channel resources that overlap, in the frequency domain (or time domain), with a DL sub-band associated with SBFD. While not shown in FIG. 3, the techniques described herein may also include, and/or apply, to SBFD communications that involve reference signal measurement and reporting. These and other features, are described in additional detail with reference to remaining Figures.

Additionally, examples described with reference to one type of sub-band (e.g., a DL sub-band) may also apply to another type of sub-band (e.g., a UL sub-band). Similarly, examples described with reference to one type of channel (e.g., a DL channel) may also apply to another type of channel (e.g., a UL channel). A DL channel may include a PDSCH or a PUSCH, and a UL channel may include a PUSCH or a PUCCH. Furthermore, examples described with reference to one type of RE (e.g., a PRB or RBG) may also be applicable to another type of RE (e.g., an RBG).

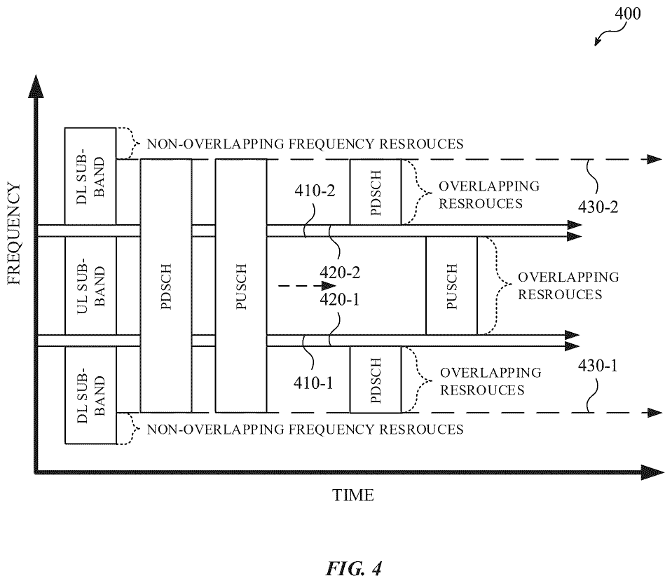

FIG. 4 is a diagram of an example 400 for SBFD communications when sub-bands overlap with PRBs of a PDSCH or a PUSCH according to one or more implementations described herein. As shown, example 400 may include a table with a vertical axis of frequency and a horizontal axis of time. An SBFD communication may include one or more DL sub-bands and one or more UL sub-bands. The sub-bands may be separated by gaps, as represented by frequencies 410-1 and 410-2 of the UL sub-band relative to the frequencies 420-1 and 420-2 of the DL sub-bands. Some portions of the frequencies of the sub-bands may overlap with frequency resources allocated to a PDSCH or a PUSCH. Other portions of the frequencies of the sub-bands may not overlap with the frequency resources allocated to the PDSCH or the PUSCH.

Base station 222 may allocate resources to UE 210 via a type 1 allocation of frequency resources. A type 1 allocation may involve consecutive RBs of a specified BWP being allocated using a starting RB parameter and a number of RBs parameter. DCI for type 1 allocations may include a RIV associated with a corresponding set of parameters for the allocation (e.g., the starting PRB and the number of PRBs). In some implementations, when an allocated frequency domain resource (e.g., a PDSCH or a PUSCH) partially overlaps with a corresponding sub-band, only the allocated frequency domain resources that overlaps with the corresponding sub-band may be used. As mentioned above, the type 1 frequency domain resource allocation may be based on RIV corresponding to a starting virtual RB and a length in terms of contiguously allocated RBs. As shown in example, 400, the PDSCH partially overlaps with DL sub-bands, and the PUSCH partially overlaps with the UL sub-band. Base station 222 and/or UE 210 may engage in SBFD communications using the overlapping PDSCH frequency resources and the overlapping PUSCH resources.

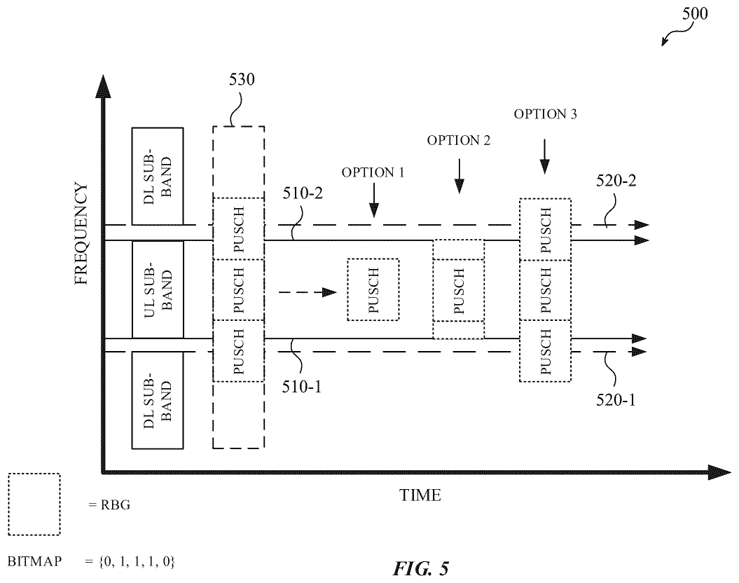

FIG. 5 is a diagram of an example 500 for SBFD communications when a sub-band partially overlaps with RBGs of a PUSCH according to one or more implementations described herein. As shown, example 500 may include a table with a vertical axis of frequency and a horizontal axis of time. An SBFD communication may include one or more DL sub-bands and one or more UL sub-bands. The sub-bands may be separated by gaps, as represented by frequencies 510-1 and 510-2 of the UL sub-band relative to the frequencies 520-1 and 520-2 of the DL sub-bands. Some portions of the frequencies of the sub-bands may overlap with frequency resources allocated to a PDSCH or a PUSCH. Other portions of the frequencies of the sub-bands may not overlap with the frequency resources allocated to the PDSCH or the PUSCH.

Base station 222 may allocate resources to UE 210 via a type 0 allocation of frequency resources. A type 0 allocation may involve consecutive PRBs being granted as an RBG. A PRB may consist of a specific number of subcarriers in the frequency domain. PDSCH resources and/or PUSCH resources may be allocated in terms of RBGs. The RBGs may or may not be consecutive, and the number of PRBs in an RBG may vary depending on a BWP size and configuration type. A bitmap in DCI may be used to indicate the RBGs that carry PDSCH or PUSCH data.

Example 500 includes a PUSCH comprising three RBGs of a possible RBGs, as indicated by a bitmap: {0, 1, 1, 0}. The three RBGs of the PUSCH partially overlaps with the UL sub-band. As indicated by Option 1, in some implementations, base station 222 and/or UE 210 may engage in SBFD communications using only RBGs of an allocated frequency resource (e.g., a PUSCH) that are fully included, or that fully overlap, with a corresponding sub-band (e.g., the UL-sub-band). As indicated by Option 2, base station 222 and/or UE 210 may engage in SBFD communications using fully overlapping RBGs and PRBs, of partially overlapping RBGs, to the extent the PRBs overlap with the corresponding sub-band.

As indicated by Option 3, base station 222 and/or UE 210 may engage in SBFD communications using all of the fully overlapping RBGs and partially overlapping RBGs. In scenarios represented by Options 1-3, an RBG for one type of resource (e.g., PUSCH) may not be used when the RBG fully overlaps with an opposite type of sub-band (e.g., a DL sub-band). While example 500 primarily relates to PUSCH resources that overlap with a UL sub-band, the techniques described herein may also be applied to PDSCH resources that overlap with the DL sub-bands. For example, base station 222 and/or UE 210 may engage in SBFD communications by applying one of options 1-3 to PUSCH resources and another one of options 1-3 to PDSCH resources.

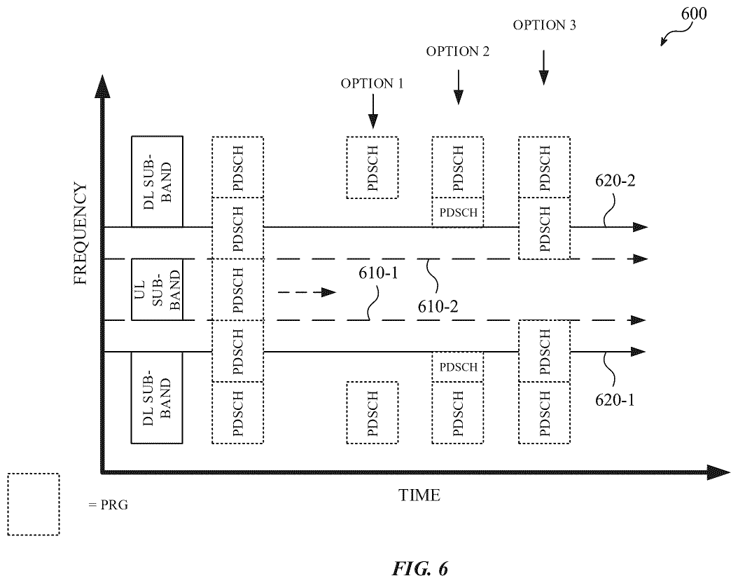

FIG. 6 is a diagram of an example 600 for SBFD communications when a sub-band partially overlaps with RBGs of a PDSCH according to one or more implementations described herein. As shown, example 600 may include a table with a vertical axis of frequency and a horizontal axis of time. An SBFD communication may include one or more DL sub-bands and one or more UL sub-bands. The sub-bands may be separated by gaps, as represented by frequencies 610-1 and 610-2 of the UL sub-band relative to the frequencies 620-1 and 620-2 of the DL sub-bands. Some portions of the frequencies of the sub-bands may overlap with frequency resources allocated to a PDSCH or a PUSCH. Other portions of the frequencies of the sub-bands may not overlap with the frequency resources allocated to the PDSCH or the PUSCH.

Base station 222 may allocate resources to UE 210 via a precoding resource block group (PRG). A PRG may include 2 PRBs, 4 PRBs, or wideband. Here, wideband may include all the allocated PRBs. PRGs may be used to support DL frequency selective precoding for a PDSCH or another type of channel. PRGs may enable frequency selective precoding.

As indicated by Option 1, in some implementations, base station 222 and/or UE 210 may engage in SBFD communications using only PRGs that fully overlap with a sub-band. As indicated by Option 2, in some implementations, base station 222 and/or UE 210 may engage in SBFD communications using PRGs that fully overlap with a sub-band and PRBs, of partially overlapping PRGs, to the extent the PRGs overlap with the corresponding sub-band. As indicated by Option 3, base station 222 and/or UE 210 may engage in SBFD communications using all of the fully overlapping PRGs and partially overlapping PRGs. In any of options 1-3, base station 222 and/or UE 210 may not use PRGs, of a PDSCH, that fully overlap with a UL sub-band.

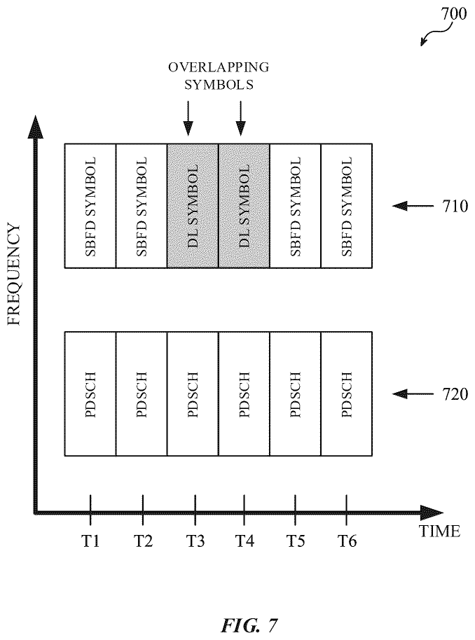

FIG. 7 is a diagram of an example 700 for SBFD communications when SBFD symbols overlap with PDSCH symbols according to one or more implementations described herein. As shown, example 700 may include a table with a vertical axis of frequency and a horizontal axis of time. An SBFD communication may include one or more symbols arranged as one or more slots. A PDSCH or a PUSCH may also include one or more symbols arranged as one or more slots. Example 700 includes SBFD symbols 710 and PDSCH symbols 720 associated with times (T) 1-6 of a slot. For purposes of explaining example 700, assume that two of the PDSCH symbols overlaps with two SBFD symbols, as indicated by “DL symbol.” The other SBFD symbols may correspond to UL communications.

Base station 222 may allocate frequency and time resources to UE 210 for SBFD communications. In some implementations, SBFD communications may be limited to slots of a PDSCH or a PUSCH resource that fully overlaps with all of the symbols of an SBFD slot. In such a scenario, the SBFD communication may not include the time resources of the PDSCH of example 700. In other implementations, SBFD communications may include slots of a PDSCH or a PUSCH resource that partially overlap (e.g., more than one overlapping symbol) with the symbols of an SBFD slot. In such a scenario, the SBFD communication may include the time resources of the PDSCH of example 700. While example 700 is directed to a scenario involving PDSCH resource for SBFD communications, the techniques described by example 700 may also be applied to using PUSCH resources for SBFD communications.

Additionally, in some implementations, SBFD communications may be limited to frequency domain resources being the same for all PDSCH and/or PUSCH symbols of the same slot. For example, when the PDSCH resources of example 700 are applied to SBFD communications, the SBFD symbols (e.g., the overlapping symbols) may use the same frequency domain resources (e.g., the same PRBs, RBGs, PRGs, etc.). In other implementations, SBFD communications may include frequency domain resources being different for different PDSCH and/or PUSCH symbols of the same slot. when the PDSCH resources of example 700 are applied to SBFD communications, the SBFD symbols (e.g., the overlapping symbols) may use different frequency domain resources (e.g., different PRBs, RBGs, PRGs, etc.).

In some implementations, slot aggregation may be used by base station 222 and/or UE 210. Slot aggregation (or repetition) may include a scenario in which a transmission may span two or more slots in order to achieve improved coverage and/or reduced overhead. In some implementations, SBFD communications may be limited to frequency domain resources being the same for all PDSCH and/or PUSCH slots of a slot aggregation scenario. In other implementations, SBFD communications may include frequency domain resources being different for different PDSCH and/or PUSCH slots of a slot aggregation scenario.

When different symbols of the same slot correspond to different frequency domain resources, a transport block (TB) size, for modulation and coding scheme (MCS), may be determined before or after the different frequency domains have been resolved for the SBFD communications. A TB may include a data unit utilized to convey user data and control information between the base station and UE. A TB may include encoded data bits, including payload data and control information such as error correction codes and modulation scheme indicators. The size and configuration of a TB may vary depending on factors such as channel conditions, modulation scheme, and system parameters. A TB may be mapped onto one or more PRBs during transmission. In some implementations, when slot aggregation is applied, TB size may be determined based on a first repletion slot of a PDSCH or PUSCH transmission. In other implementations involving slot aggregation, TB size may be determined based on the repetition slot that carries the largest number of frequency domain resources. In yet other implementations involving slot aggregation, TB size may be determined based on the repetition slot that carries the smallest number of frequency domain resources.

In some implementations, the techniques of example 700 may be applied to a PDCCH, where a PDCCH monitoring occasion includes two or more symbols that overlap with the symbols of a SBFD slot. A PDCCH monitoring occasion may a include period of time during which UE 210 may monitor one or more slots of a PDCCH for control information from base station 222. In some implementations, SBFD communications may be limited to slots of a PDCCH monitoring occasion that fully overlap with all of the symbols of an SBFD slot. In other implementations, SBFD communications may include slots of a PDCCH monitoring occasion that partially overlap (e.g., more than one symbol) with the symbols of an SBFD slot.

One or more of the techniques described herein may also involve PDCCH candidates and/or a CCE. A PDCCH candidate may include possible locations within a search space where a PDCCH may be transmitted. UE 210 may monitor PDCCH candidates based on assigned search spaces. The PDCCH may be transmitted in a specific search space, which may be defined by frequency and time resources. A CCE may be allocated within the frequency domain and time domain of a PDCCH and may include a certain number of REGs. A REG may include a resource block in the frequency domain and one or more symbols in the time domain. A CCE may be used to convey control information such as scheduling assignments, HARQ feedback, power control commands, and other signaling messages from a base station.

For SBFD communications that involve PDCCH symbols that overlap with two or more SBFD symbols, UE 210 may or may not process a monitored PDCCH candidate or non-overlapping CCE for channel estimation that partially overlaps with a DL sub-band. In some implementations, UE 210 may not be configured to do so, while in other implementations UE 210 may do so. Whether UE 210 does so may depend on one or more factors, such as a UE capability report that indicates an ability of UE 210 to do so. Partially overlapping with a DL sub-band may mean that at least one REs is not overlapping with DL sub-band.

In some implementations, when UE 210 does not process a monitored PDCCH candidate or non-overlapping CCE, a corresponding PDCCH candidate or non-overlapping CCE may be counted as a blind decode (BD) or CCE towards a maximum number of BDs and/or CCEs that UE 210 may process. Blind decoding may refer to UE 210 evaluating search spaces of a PDCCH for relevant control information (e.g., DCI), without knowing a size or location of the DCI beforehand. There may be a limit to a maximum number of blind decodes and non-overlapping CCEs per slot for channel estimation purposes.

In other implementations, when UE 210 does not process a monitored PDCCH candidate or non-overlapping CCE, a corresponding PDCCH candidate or non-overlapping CCE may not be counted as a BD or CCE towards a maximum number of BDs or CCEs that UE 210 may process. Whether a corresponding PDCCH candidate or non-overlapping CCE is counted may depend on a UE capability report. For example, the UE capability report may indicate that when UE 210 does not process a PDCCH candidate or non-overlapping CCE, the corresponding PDCCH and non-overlapping CCE is or is not counted towards the maximum number of BDs or CCEs. In some implementations, SBFD communications may not include additional, or linked, search spaces or PDCCH candidates. For example, when a PDCCH includes symbols that overlap with SBFD symbols, and when two search spaces are linked for PDCCH reliability (repetition), UE 210 may not be expected or configured to process a pair of linked PDCCH candidate in a pair of linked search space that includes a different number of REs (e.g., a different number of frequency domain resources).

In some implementations, the technique of example 700 may be applied to a PUCCH, where a PDCCH monitoring occasion includes two or more symbols that overlap with the symbols of a SBFD slot. In some implementations, SBFD communications may be limited to slots of a PUCCH resource that fully overlap with all of the symbols of an SBFD slot. In other implementations, SBFD communications may include slots of a PUCCH resources that fully overlap and partially overlap (e.g., more than one symbol) with the symbols of an SBFD slot.

In some implementations, slot aggregation may be used by base station 222 and/or UE 210. Slot aggregation (or repetition) may include a scenario in which a transmission may span two or more slots in order to achieve improved coverage and/or reduced overhead. In some implementations, SBFD communications may be limited to frequency domain resources being the same for all PUCCH slots of a slot aggregation scenario. In other implementations, SBFD communications may include frequency domain resources being different for different PUCCH slots of a slot aggregation scenario.

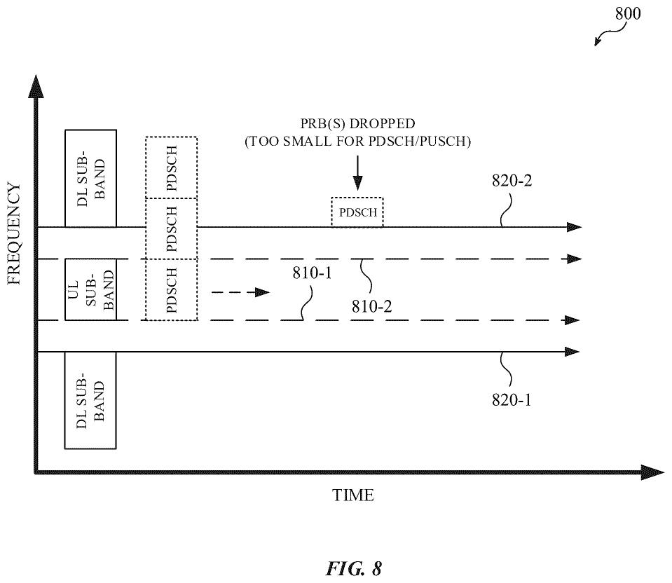

FIG. 8 is a diagram of an example 800 for SBFD communications when a sub-band partially overlaps with PRBs of a PDSCH with slot aggregation according to one or more implementations described herein. As shown, example 800 may include a table with a vertical axis of frequency and a horizontal axis of time. An SBFD communication may include one or more DL sub-bands and one or more UL sub-bands. The sub-bands may be separated by gaps, as represented by frequencies 810-1 and 810-2 of the UL sub-band relative to the frequencies 820-1 and 820-2 of the DL sub-bands. Some portions of the frequencies of the sub-bands may overlap with frequency resources allocated to a PDSCH or a PUSCH. Other portions of the frequencies of the sub-bands may not overlap with the frequency resources allocated to the PDSCH or the PUSCH.

Base station 222 may allocate resources to UE 210 using any one or combinations of the techniques described above. Example 800 may include a scenario in which slot aggregation is being applied and after resolution of a frequency domain resource allocation has been addressed for an overlapping SBFD symbol, and different slot repetitions have different frequency domain resource allocations. In such scenarios, if the number of frequency domain resources for a repetition is too small, the corresponding PDSCH reception or PUSCH transmission may be omitted. Determining whether the number of frequency domain resources for a repetition is too small may include applying a threshold to the SBFD communication. In some implementations, the threshold may be an absolute number of frequency domain resources (e.g., the number of PRBs, RBGs, PRGs, TBs, etc.). In some implementations, the threshold may be a coding rate.

In some implementations, the techniques of example 800 may be applied to SBFD communications relating to PUCCH resource selection. For example, base station 222 may configure up to 4 PUCCH resource sets and use a PUCCH resource indicator to indicate a selection of PUCCH resources of a corresponding PUCCH resource set. UE 210 may select the PUCCH resource set based on a UL control indicator (UCI) size and the PUCCH resource using the PUCCH resource indicator, if due to the resolution with SBFD, a resulting number of frequency resources is below a threshold. When the resolution of frequency resources with SBFD results in frequency resources above the threshold, UE 210 may use the next PUCCH resource set corresponding to a larger UCI size and select a new PUCCH resource using the same PUCCH resource indicator. In some implementations, the threshold may be an absolute number of frequency domain resources (e.g., the number of PRBs, RBGs, PRGs, TBs, etc.). In some implementations, the threshold may be a coding rate.

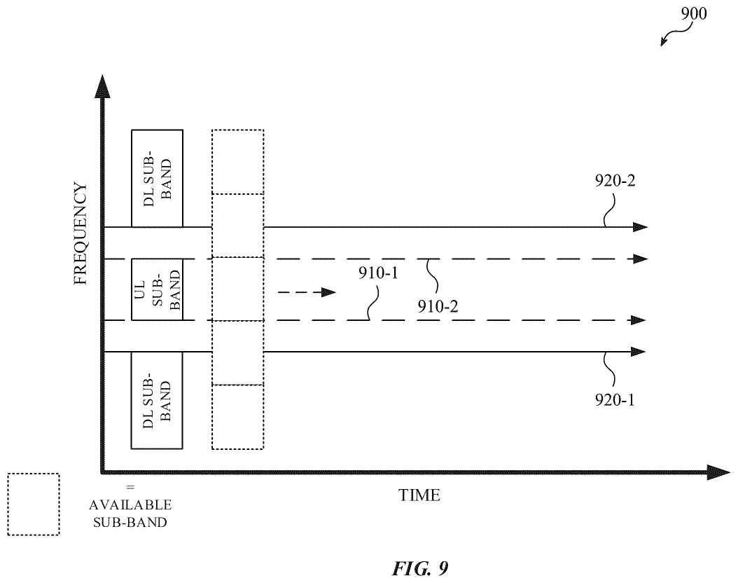

FIG. 9 is a diagram of an example 900 for SBFD communications when CSI measurements are performed for sub-bands of the SBFD communications according to one or more implementations described herein. As shown, example 900 may include a table with a vertical axis of frequency and a horizontal axis of time. An SBFD communication may include one or more DL sub-bands and one or more UL sub-bands. The sub-bands may be separated by gaps, as represented by frequencies 910-1 and 910-2 of the UL sub-band relative to the frequencies 920-1 and 920-2 of the DL sub-bands. The DL sub-bands and the UL sub-band illustrated in example 900 may represent sub-bands identified by base station 222 and/or UE 210 as being for SBFD communications. Frequency resources available for communications between base station 222 and UE 210 may include or be arranged as multiple contiguous sub-bands.

Some of the available sub-bands may fully overlap in the frequency domain with DL sub-bands and/or UL sub-bands identified for SBFD communications. Some of the available sub-bands may partially overlap in the frequency domain with DL sub-bands and/or UL sub-bands identified for SBFD communications. Some of the available sub-bands may not overlap in the frequency domain with DL sub-bands and/or UL sub-bands identified for SBFD communications.

UE 210 may be configured to perform CSI measurements on one or more of the frequency resources (e.g., sub-bands) allocated for SBFD communications. For a sub-band that is non-overlapping with a DL sub-band, UE 210 may not be expected or configured to measure and report CSI for the sub-band. Additionally, or alternatively, base station 222 may not be expected or configured to provide UE 210 with an indication or parameter for measuring non-overlapping sub-bands. For example, base station 222 may not provide UE 210 with a “1” in a 1-bit csi-ReportingBand field of a CSI-ReportConfig IE corresponding to non-overlapping sub-bands. By contrast, base station 222 may be configured to provide UE 210 with an indication or parameter for measuring fully overlapping and/or partially overlapping sub-bands. Additionally, UE 210 may be configured to measure and report a CSI measurement on fully overlapping and/or partially overlapping sub-bands.

A sub-band that fully or partially overlaps with a DL sub-band for SBFD communications may be configured for DL CSI measurements. Each sub-band may include multiple contiguous PRBs. The size of the sub-band may be configured in CSI-ReportConfig IE, sent by base station 222 to UE 210, using a subbandSize parameter. Additionally, or alternatively, base station 222 may use a bitmap (e.g., csi-ReportingBand) of a CSI-ReportConfig IE, to inform UE 210 of which sub-band should be measured and reported.

In some implementations, UE 210 may not be expected or configured to perform and report CSI measurements on sub-bands that partially overlap with DL sub-bands for SBFD communications. Additionally, or alternatively, base station 222 may not be configured to provide UE 210 with a “1” in a 1-bit csi-ReportingBand field of a CSI-ReportConfig IE for partially overlapping sub-bands. In other implementations, UE 210 may be expected or configured to measure and report CSI for partially overlapping sub-bands of a DL sub-band for SBFD communications when base station 222 indicates “1” in a 1-bit csi-ReportingBand field of a CSI-ReportConfig IE for partially overlapping sub-bands.

UE 210 may provide UE capability to base station 222, indicating whether UE 210 is capable of measuring and reporting CSI for partially overlapping sub-bands. Additionally, or alternatively, base station 222 may determine whether to configure UE 210 to measure and report CSI for partially overlapping sub-bands based on the UE capability information. In some implementations, UE 210 may determine whether to measure and report CSI for partially overlapping sub-bands based on whether the number of overlapping REs (e.g., PRBs) of the partially overlapping sub-band are greater than or equal to a threshold for CSI measurement and reporting.

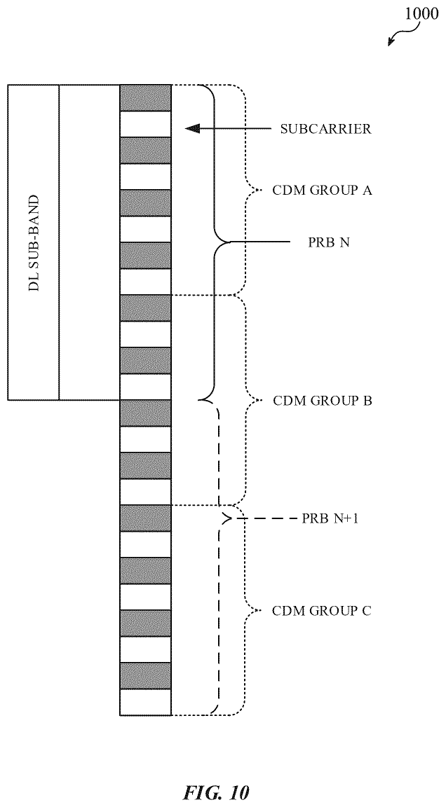

FIG. 10 is a diagram of an example 1000 for SBFD communications when a DL sub-band partially overlaps with a PRB of a code-division multiplexing (CDM) group of a PDSCH demodulation reference signals (DMRS) according to one or more implementations described herein. As shown, example 1000 may include CDM group A, CDM group B, and CDM group C. CDM group A and half of CDM group B may correspond to PRB N, while the other half of CDM group B and CDM group C may correspond to PRB N+1. The PRB of CDM group A and the half of CDM group B may correspond to the DL sub-band. CDM group B may be referred to as an orphan CDM group for spanning two consecutive PRBs, where only one PRB fully overlaps with a DL sub-band. Each PRB may include twelve subcarriers.

Example 1000 may correspond to a scenario in which SBFD communications involve frequency division (FD) orthogonal cover code (OCC) 4 (FD-OCC4) for a type 1 PDSCH DMRS with a cyclic prefix (CP) OFDM (CP-OFDM) waveform. Orthogonal codes (OC) may include sets of binary sequences with an inner product of zero, except when two identical sequences are multiplied together, in which case the inner product may be equal to the length of the sequence. The orthogonality may enable multiple sequences to be transmitted simultaneously without interfering with each other. In OCC, orthogonal codes may be used to encode the transmitted data. An available frequency spectrum into multiple subchannels (or sub-carriers) and assign orthogonal codes may be assigned to each subchannel. In this manner, multiple transmission may occur simultaneously over different subchannels without causing interference. FD-OCC4 may include using either Hadamard sequences or discrete fourier transform (DFT) sequences.

A DMRS may include a special type of physical layer signal configured to function as a reference signal for decoding a PDSCH. A DMRS may have a configuration type 1 or 2. In configuration type 1, a minimum REG in the frequency domain may be one RE (e.g., 1 PRB). In configuration type 2, the minimum REG in the frequency domain may be two consecutive REs (e.g., 2 PRB). CDM may include a multiplexing process in which information may be combined for instantaneous transmission of a frequency band or sub-band. A CDM group may include multiple contiguous REs for which OCC may be applied in a time and/or frequency domain. A CP-OFDM waveform may include wireless resources being differentiated based on a CP applied to OFDM signals.

In some implementations, base station 222 may not be configured to schedule an SBFD communication for the DL sub-band given an orphaned CDM group (CDM group B) corresponding to the DL sub-band. In such a scenario, a lowest PRB of the DL sub-band may have an even number of PRBs to point A, and a highest PRB of the DL sub-band may have an even number of PRBs to point A, and the DL sub-band may have an even number of PRBs. Point A may be the common resource block (e.g., common resource block 0).

In other implementations, base station 222 may be configured to schedule an SBFD communication for the DL sub-band despite the orphaned CDM group. In one example, only the PRB that fully overlaps with the DL sub-band may be used or allocated to UE 210 for SBFD communications. In another example, the PRB that fully overlaps with the DL sub-band and the PRB that partially overlaps with the DL sub-band may be scheduled or allocated to UE 210 for SBFD communications. In yet another example, neither PRB may be scheduled or allocated to UE 210 for SBFD communications. Whether base station 222 allocates an orphaned CDM group to UE 210 may depend on whether UE 210 has provided base station 222 with UE capability information indicating that UE 210 is able to support an orphaned CDM group.

The techniques described above with reference to example 1000 may also be applied to a scenario in which SBFD communications involve FD-OCC4 for a type 1 PUSCH DMRS with a CP-OFDM waveform. In some implementations, the DL sub-band may be scheduled or allocated to UE 210 for SBFD communications based on the configuration of base station 222. In other implementations, the DL sub-band may not be scheduled or allocated to UE 210 for SBFD communications. In other implementations, base station 222 may be configured to schedule an SBFD communication for the DL sub-band despite the orphaned CDM group. In one example, only PRBs that fully overlap with the DL sub-band may be used or allocated to UE 210 for SBFD communications. In another example, both PRBs that fully overlap with the DL sub-band and PRBs that partially overlap with the DL sub-band may be scheduled or allocated to UE 210 for SBFD communications. In yet another example, neither PRBs may be scheduled or allocated to UE 210 for SBFD communications. Whether base station 222 allocates an orphaned CDM group to UE 210 may depend on whether UE 210 has provided base station 222 with UE capability information indicating that UE 210 is able to support an orphaned CDM group.

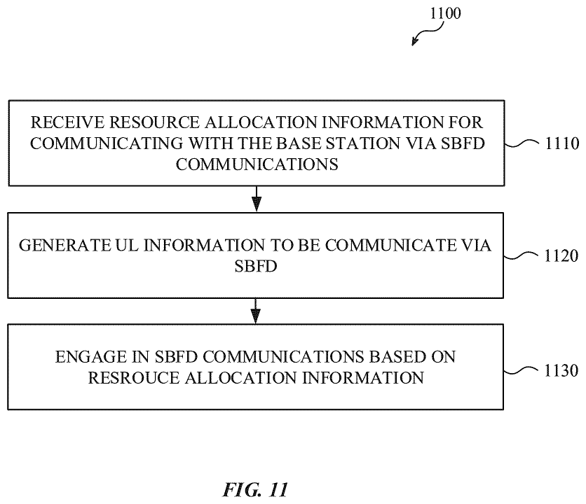

FIG. 11 is a diagram of an example process 1100 for SBFD communications according to one or more implementations described herein. Process 1100 may be implemented by one or more baseband processors and/or UE 210. In some implementations, some or all of process 1100 may be performed by one or more other systems or devices, including one or more of the devices of FIG. 2. Additionally, process 1100 may include one or more fewer, additional, differently ordered and/or arranged operations than those shown in FIG. 11. In some implementations, some or all of the operations of process 1100 may be performed independently, successively, simultaneously, etc., of one or more of the other operations of process 1100. As such, the techniques described herein are not limited to a number, sequence, arrangement, timing, etc., of the operations or processes depicted in FIG. 11.

As shown, process 1100 may include receiving, from a base station, resource allocation information for communicating with the base station via SBFD communications (block 1110). The resource allocation information may include an indication of time and/or reroutes allocated to SBFD communications. For example, the resource allocation information may include DL channel resources that overlap, in a frequency domain, with a DL sub-band associated with the SBFD communications. The DL channel resources may correspond to a PDSCH or a PDCCH. Another example of the resource allocation information may include UL channel resources that overlap, in the frequency domain, with a UL sub-band associated with the SBFD communications. The UL channel resources may correspond to a PUSCH or a PUCCH. In some implementations, the resource allocation information may correspond to reference signal resources and/or resources for measuring and reporting a reference signal.

Process 1100 may also include generating UL information to be communicated to the base station (block 1120). The UL information may include any type of information, such as user data or control data, to be communicated from UE 210 to base station 222. Process 1100 may further include causing radio frequency (RF) circuitry to engage in SBFD communications (block 1130). For example, UE 210 may use an antenna, or another type of wireless interface feature, to send and receive information to and from base station 222. Engaging in SBFD communications may therefore include transmitting the UL information via UL channel resources that overlap in the frequency domain with the UL sub-band. Engaging in SBFD communications may also include receiving DL information from base station 222 via DL channel resources that overlap with the DL sub-band. Example process 1100 may further include one or more, or any combination, of additional operations, which may be described as an aspect, feature, or example of the techniques described herein.

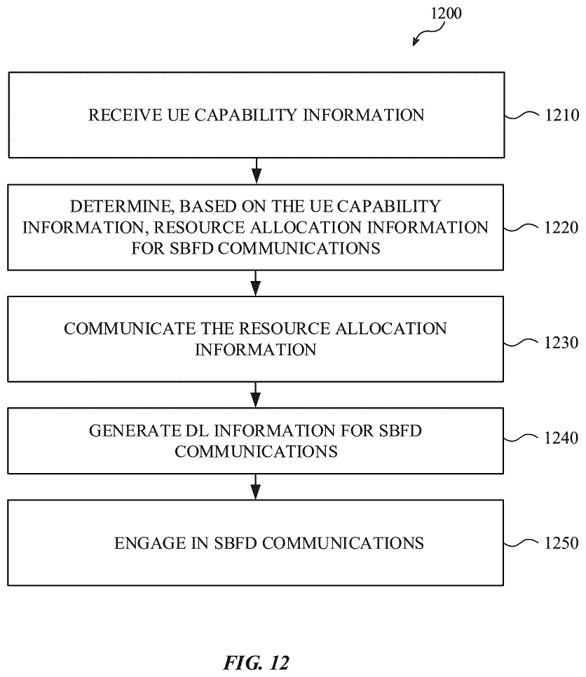

FIG. 12 is a diagram of an example process 1200 for SBFD communications according to one or more implementations described herein. Process 1200 may be implemented by base station 222. In some implementations, some or all of process 1200 may be performed by one or more other systems or devices, including one or more of the devices of FIG. 2. Additionally, process 1200 may include one or more fewer, additional, differently ordered and/or arranged operations than those shown in FIG. 12. In some implementations, some or all of the operations of process 1200 may be performed independently, successively, simultaneously, etc., of one or more of the other operations of process 1200. As such, the techniques described herein are not limited to the number, sequence, arrangement, timing, etc., of the operations or processes depicted in FIG. 12.

As shown, process 1200 may include receiving UE capability information that includes an indication of an ability of UE 210 to engage in SBFD communications (block 1210). For example, UE 210 may communicate information to base station 222 about the capabilities of UE 210. The information may relate to the ability of UE 210 to engage in SBFD communications generally or under one or more conditions, use time and/or frequency resources, reference signal measurement and reporting capabilities, etc.

Process 1200 may also include determining, based on the UE capability information, resource allocation information for SBFD communications between base station 222 and UE 210 (block 1220). The resource allocation information may include an indication of time and/or reroutes allocated to SBFD communications. For example, the resource allocation information may include DL channel resources that overlap, in a frequency domain, with a DL sub-band associated with the SBFD communications. The DL channel resources may correspond to a PDSCH or a PDCCH. Another example of the resource allocation information may include UL channel resources that overlap, in the frequency domain, with a UL sub-band associated with the SBFD communications. The UL channel resources may correspond to a PUSCH or a PUCCH. In some implementations, the resource allocation information may correspond to reference signal resources and/or resources for measuring and reporting a reference signal. Process 1200 may include base station 222 communicating the resource allocation information to UE 210 (block 1230).

Process 1200 may also include generating DL information to be communicated to the UE 210 (block 1240) and engaging in SBFD communications with UE 210 (block 1250). For example, base station 222 may generate DL information to be communicated to UE 210 via DL channel resources allocated to SBFD communications. Base station 222 may engage in SBFD communications with UE 210 by sending the DL information to UE 210 via the time and frequency DL resources allocated for SBFD communications, and by receiving UL information from UE 210 via the time and frequency UL resources allocated for SBFD communications. Example process 1200 may further include one or more, or any combination, of additional operations, which may be described as an aspect, feature, or example of the techniques described herein.

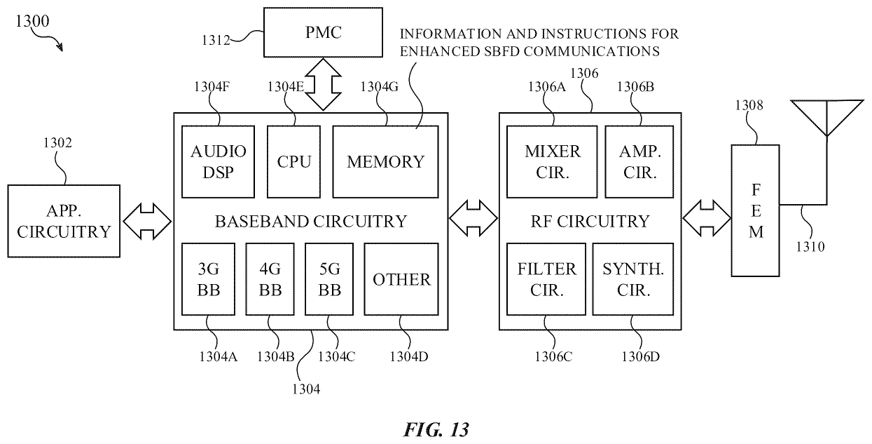

FIG. 13 is a diagram of an example of components of a device according to one or more implementations described herein. In some implementations, the device 1300 can include application circuitry 1302, baseband circuitry 1304, RF circuitry 1306, front-end module (FEM) circuitry 1308, one or more antennas 1310, and power management circuitry (PMC) 1312 coupled together at least as shown. The components of the illustrated device 1300 can be included in a UE or a RAN node. In some implementations, the device 1300 can include fewer elements (e.g., a RAN node may not utilize application circuitry 1302, and instead include a processor/controller to process IP data received from a CN or an Evolved Packet Core (EPC)). In some implementations, the device 1300 can include additional elements such as, for example, memory/storage, display, camera, sensor (including one or more temperature sensors, such as a single temperature sensor, a plurality of temperature sensors at different locations in device 1300, etc.), or input/output (I/O) interface. In other implementations, the components described below can be included in more than one device (e.g., said circuitries can be separately included in more than one device for Cloud-RAN (C-RAN) implementations).

The application circuitry 1302 can include one or more application processors. For example, the application circuitry 1302 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1300. In some implementations, processors of application circuitry 1302 can process IP data packets received from an EPC.

The baseband circuitry 1304 can include circuitry such as, but not limited to, one or more single-core or multi-core processors. The baseband circuitry 1304 can include one or more baseband processors or control logic to process baseband signals received from a receive signal path of the RF circuitry 1306 and to generate baseband signals for a transmit signal path of the RF circuitry 1306. Baseband circuity 1304 can interface with the application circuitry 1302 for generation and processing of the baseband signals and for controlling operations of the RF circuitry 1306. For example, in some implementations, the baseband circuitry 1304 can include a 3G baseband processor 1304A, a 4G baseband processor 1304B, a 5G baseband processor 1304C, or other baseband processor(s) 1304D for other existing generations, generations in development or to be developed in the future (e.g., 5G, 6G, etc.). The baseband circuitry 1304 (e.g., one or more baseband processors 1304A-D) can handle various radio control functions that enable communication with one or more radio networks via the RF circuitry 1306. In other implementations, some or all of the functionality of baseband processors 1304A-D can be included in modules stored in the memory 1304G and executed via a Central Processing Unit (CPU) 1304E. The radio control functions can include, but are not limited to, signal modulation/demodulation, encoding/decoding, radio frequency shifting, etc. In some implementations, modulation/demodulation circuitry of the baseband circuitry 1304 can include Fast-Fourier Transform (FFT), precoding, or constellation mapping/de-mapping functionality. In some implementations, encoding/decoding circuitry of the baseband circuitry 1304 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1304G may receive and/or store information and instructions for enabling SBFD communications as described herein. Device 1300 may receive from base station 222, resource allocation information that may include DL channel resources and/or UL channel resources that overlap, in a frequency domain and/or a time domain, with sub-bands associated with SBFD communications. Device 1300 may generate UL information to be communicated to the base station and engage in SBFD communication by: transmitting, via the UL information using the UL channel resources that overlap in the frequency domain with the UL sub-band; and receiving, via the DL channel resources that overlap with the DL sub-band, DL information from the base station. Many other aspects and examples of the techniques are also described herein. The DL channel may include a PDSCH or a PUSCH. The UL channel may include a PUSCH or a PUCCH. The techniques described herein may also apply to SBFD communications that involve reference signal measurement and reporting, as well as many different types of REs. Many other aspects and examples are also described herein.

In some implementations, the baseband circuitry 1304 can include one or more audio digital signal processor(s) (DSP) 1304F. The audio DSPs 1304F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1304 and the application circuitry 1302 can be implemented together such as, for example, on a system on a chip (SOC).

In some implementations, the baseband circuitry 1304 can provide for communication compatible with one or more radio technologies. For example, in some implementations, the baseband circuitry 1304 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1304 is configured to support radio communications of more than one wireless protocol can be referred to as multi-mode baseband circuitry.

RF circuitry 1306 can enable communication with wireless networks using modulated electromagnetic radiation through a non-solid medium. In various implementations, the RF circuitry 1306 can include switches, filters, amplifiers, etc. to facilitate the communication with the wireless network. RF circuitry 1306 can include a receive signal path which can include circuitry to down-convert RF signals received from the FEM circuitry 1308 and provide baseband signals to the baseband circuitry 1304. RF circuitry 1306 can also include a transmit signal path which can include circuitry to up-convert baseband signals provided by the baseband circuitry 1304 and provide RF output signals to the FEM circuitry 1308 for transmission.

In some implementations, the receive signal path of the RF circuitry 1306 can include mixer circuitry 1306A, amplifier circuitry 1306B and filter circuitry 1306C. In some implementations, the transmit signal path of the RF circuitry 1306 can include filter circuitry 1306C and mixer circuitry 1306A. RF circuitry 1306 can also include synthesizer circuitry 1306D for synthesizing a frequency for use by the mixer circuitry 1306A of the receive signal path and the transmit signal path. In some implementations, the mixer circuitry 1306A of the receive signal path can be configured to down-convert RF signals received from the FEM circuitry 1308 based on the synthesized frequency provided by synthesizer circuitry 1306D. The amplifier circuitry 1306B can be configured to amplify the down-converted signals and the filter circuitry 1306C can be a low-pass filter (LPF) or band-pass filter (BPF) configured to remove unwanted signals from the down-converted signals to generate output baseband signals. Output baseband signals can be provided to the baseband circuitry 1304 for further processing. In some implementations, the output baseband signals can be zero-frequency baseband signals, although this is not a requirement. In some implementations, mixer circuitry 1306A of the receive signal path can comprise passive mixers, although the scope of the implementations is not limited in this respect.

In some implementations, the mixer circuitry 1306A of the transmit signal path can be configured to up-convert input baseband signals based on the synthesized frequency provided by the synthesizer circuitry 1306D to generate RF output signals for the FEM circuitry 1308. The baseband signals can be provided by the baseband circuitry 1304 and can be filtered by filter circuitry 1306C. In some implementations, the mixer circuitry 1306A of the receive signal path and the mixer circuitry 1306A of the transmit signal path can include two or more mixers and can be arranged for quadrature down conversion and up conversion, respectively. In some implementations, the mixer circuitry 1306A of the receive signal path and the mixer circuitry 1306A of the transmit signal path can include two or more mixers and can be arranged for image rejection (e.g., Hartley image rejection). In some implementations, the mixer circuitry 1306A of the receive signal path and the mixer circuitry 1406A can be arranged for direct down conversion and direct up conversion, respectively. In some implementations, the mixer circuitry 1306A of the receive signal path and the mixer circuitry 1306A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1306 can include analog-to-digital converter (ADC) and digital-to-analog converter (DAC) circuitry and the baseband circuitry 1304 can include a digital baseband interface to communicate with the RF circuitry 1306.

In some dual-mode implementations, a separate radio IC circuitry can be provided for processing signals for each spectrum, although the scope of the implementations is not limited in this respect. In some implementations, the synthesizer circuitry 1306D can be a fractional-N synthesizer or a fractional N/N+1 synthesizer, although the scope of the implementations is not limited in this respect as other types of frequency synthesizers can be suitable. For example, synthesizer circuitry 1306D can be a delta-sigma synthesizer, a frequency multiplier, or a synthesizer comprising a phase-locked loop with a frequency divider.

The synthesizer circuitry 1306D can be configured to synthesize an output frequency for use by the mixer circuitry 1306A of the RF circuitry 1306 based on a frequency input and a divider control input. In some implementations, the synthesizer circuitry 1306D can be a fractional N/N+1 synthesizer.

In some implementations, frequency input can be provided by a voltage-controlled oscillator (VCO), although that is not a requirement. Divider control input can be provided by either the baseband circuitry 1304 or the applications circuitry 1302 depending on the desired output frequency. In some implementations, a divider control input (e.g., N) can be determined from a look-up table based on a channel indicated by the applications circuitry 1302.

Synthesizer circuitry 1306D of the RF circuitry 1306 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1306D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1306 can include an IQ/polar converter.

FEM circuitry 1308 can include a receive signal path which can include circuitry configured to operate on RF signals received from one or more antennas 1310, amplify the received signals and provide the amplified versions of the received signals to the RF circuitry 1306 for further processing. FEM circuitry 1308 can also include a transmit signal path which can include circuitry configured to amplify signals for transmission provided by the RF circuitry 1306 for transmission by one or more of the one or more antennas 1310. In various implementations, the amplification through the transmit or receive signal paths can be done solely in the RF circuitry 1306, solely in the FEM circuitry 1308, or in both the RF circuitry 1306 and the FEM circuitry 1308.

In some implementations, the FEM circuitry 1308 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1306). The transmit signal path of the FEM circuitry 1308 can include a power amplifier (PA) to amplify input RF signals (e.g., provided by RF circuitry 1306), and one or more filters to generate RF signals for subsequent transmission (e.g., by one or more of the one or more antennas 1310).

In some implementations, the PMC 1312 can manage power provided to the baseband circuitry 1304. In particular, the PMC 1312 can control power-source selection, voltage scaling, battery charging, or DC-to-DC conversion. The PMC 1312 can often be included when the device 1300 is capable of being powered by a battery, for example, when the device is included in a UE. The PMC 1312 can increase the power conversion efficiency while providing desirable implementation size and heat dissipation characteristics.

While FIG. 13 shows the PMC 1312 coupled only with the baseband circuitry 1304. However, in other implementations, the PMC 1312 may be additionally or alternatively coupled with, and perform similar power management operations for, other components such as, but not limited to, application circuitry 1302, RF circuitry 1306, or FEM circuitry 1308.

In some implementations, the PMC 1312 can control, or otherwise be part of, various power saving mechanisms of the device 1300. For example, if the device 1300 is in an RRC_Connected state, where it is still connected to the RAN node as it expects to receive traffic shortly, then it can enter a state known as Discontinuous Reception Mode (DRX) after a period of inactivity. During this state, the device 1300 can power down for brief intervals of time and thus save power.

If there is no data traffic activity for an extended period of time, then the device 1300 can transition off to an RRC_Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1302 and processors of the baseband circuitry 1304 can be used to execute elements of one or more instances of a protocol stack. For example, processors of the baseband circuitry 1304, alone or in combination, can be used execute Layer 3, Layer 2, or Layer 1 functionality, while processors of the baseband circuitry 1304 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

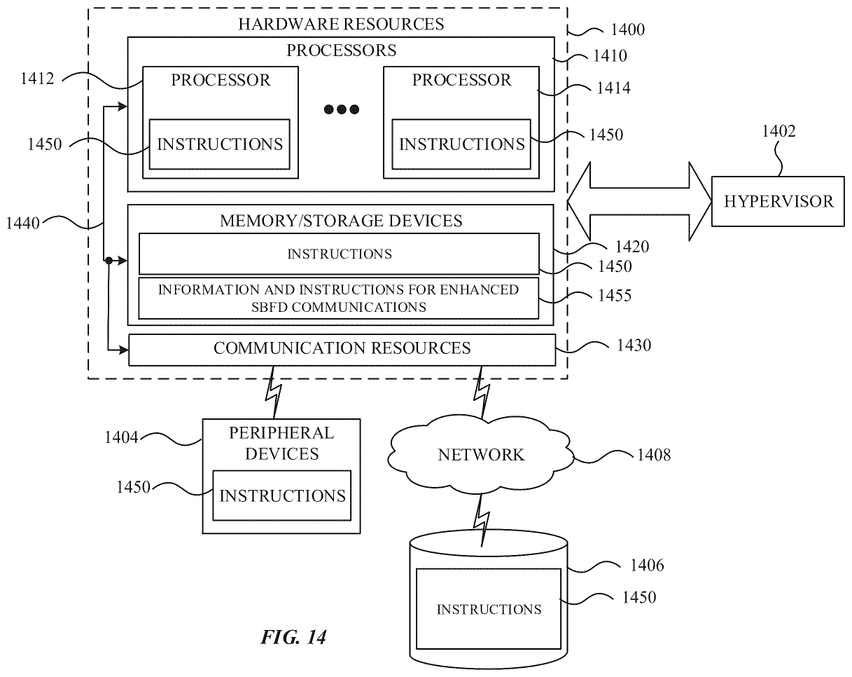

FIG. 14 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors (or processor cores) 1410, one or more memory/storage devices 1420, and one or more communication resources 1430, each of which may be communicatively coupled via a bus 1440. For implementations where node virtualization (e.g., NFV) is utilized, a hypervisor may be executed to provide an execution environment for one or more network slices/sub-slices to utilize the hardware resources 1400.

The processors 1410 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1412 and a processor 1414.

The memory/storage devices 1420 may include main memory, disk storage, or any suitable combination thereof. The memory/storage devices 1420 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1420 receive and/or store information and instructions 1455 for enabling SBFD communications as described herein. UE 210 may receive from base station 222 resource allocation information that may include DL channel resources and/or UL channel resources that overlap, in a frequency domain and/or a time domain, with sub-bands associated with SBFD communications. Device 1300 may generate UL information to be communicated to the base station and engage in SBFD communication by: transmitting, via the UL information using the UL channel resources that overlap in the frequency domain with the UL sub-band; and receiving, via the DL channel resources that overlap with the DL sub-band, DL information from the base station. Many other aspects and examples of the techniques are also described herein. The DL channel may include a PDSCH or a PUSCH. The UL channel may include a PUSCH or a PUCCH. The techniques described herein may also apply to SBFD communications that involve reference signal measurement and reporting, as well as many different types of REs. Many other aspects and examples are also described herein.

The communication resources 1430 may include interconnection or network interface components or other suitable devices to communicate with one or more peripheral devices 1404 or one or more databases 1406 via a network 1408. For example, the communication resources 1430 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1450 may comprise software, a program, an application, an applet, an app, or other executable code for causing at least any of the processors 1410 to perform any one or more of the methodologies discussed herein. The instructions 1450 may reside, completely or partially, within at least one of the processors 1410 (e.g., within the processor's cache memory), the memory/storage devices 1420, or any suitable combination thereof. Furthermore, any portion of the instructions 1450 may be transferred to the hardware resources 1400 from any combination of the peripheral devices 1404 or the databases 1406. Accordingly, the memory of processors 1410, the memory/storage devices 1420, the peripheral devices 1404, and the databases 1406 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, In example 1, which may also include one or more of the examples described herein, a baseband processor may comprise: a memory; and one or more processors configured to, when executing instructions stored in the memory, cause the one or more processors to: receive, from a base station, resource allocation information for communicating with the base station via sub-band full-duplex (SBFD) communications, the resource allocation information comprising: downlink (DL) channel resources that overlap, in a frequency domain, with a DL sub-band associated with the SBFD communications; and uplink (UL) channel resources that overlap, in the frequency domain, with a UL sub-band associated with the SBFD communications; generate UL information to be communicated to the base station; and cause the RF circuitry to engage in SBFD communication by: transmitting, via the UL channel resources that overlap in the frequency domain with the UL sub-band, the UL information as part of the SBFD communications; and receiving, via the DL channel resources that overlap with the DL sub-band, DL information as part of the SBFD communications.

In example 2, which may also include one or more of the examples described herein, the baseband processor is part of a user equipment (UE).

In example 3, which may also include one or more of the examples described herein, the one or more processors are further configured to: generate UE capability information indicating an ability of UE to engage in SBFD communications; and communicate the UE capability to the base station, wherein the resource allocation information, received from the base station, is based on the UE capability information.

In example 4, which may also include one or more of the examples described herein, the UL channel resources partially overlaps with the UL sub-band and the physical resource blocks (PRBs) of the partially overlapping portion of the UL channel resources are used to transmit the UL information; and the DL channel resources partially overlaps with the DL sub-band and the PRBs of the partially overlapping portion of the DL channel resources are used to receive the DL information.

In example 5, which may also include one or more of the examples described herein, a frequency range of the DL channel resources is greater than a frequency range of the DL sub-band, a frequency range of the UL channel resources is greater than a frequency range of the UL sub-band, and a first gap, in the frequency domain, between the DL sub-band and the UL sub-band is the same as a second gap, in the frequency domain, between the DL channel resources that overlap with the DL sub-band and the UL resources that overlap with the UL sub-band.

In example 6, which may also include one or more of the examples described herein, the UL channel resources that overlap with the UL sub-band comprise a number of PRBs that is less than a total number of PRBs of the UL channel resources and less than or equal to the total number of PRBs of the UL sub-band, and the DL channel resources that overlap with the DL sub-band comprise a number of PRBs that is less than a total number of PRBs of the DL channel resources and less than or equal to the total number of PRBs of the DL sub-band.

In example 7, which may also include one or more of the examples described herein, the resource allocation information comprises a type 1 frequency domain resource allocation that includes a resource indication value (RIV) corresponding to a starting PRB and a length of contiguously allocated PRBs.

In example 8, which may also include one or more of the examples described herein, the DL channel resources comprise at least one of: a physical DL shared channel (PDSCH), or a physical DL control channel (PDCCH), and the UL channel resources comprise at least one of: a physical UL shared channel (PUSCH); or a physical UL control channel (PDCCH).

In example 9, which may also include one or more of the examples described herein, the resource allocation information comprise a type 0 domain resource allocation include a bitmap indicating a resource allocation of at least one resource block group (RBG) to the DL channel or the UL channel, each RBG of the at least one RBG comprising a number of contiguous PRBs.

In example 10, which may also include one or more of the examples described herein, the UL channel resources comprise a plurality of resource block groups (RBGs), the plurality of RBGs comprising: at least one RBG that fully overlaps, in the frequency domain, with the UL sub-band, at least one RBG that partially overlaps, in the frequency domain, with the UL sub-band. And the UL information is transmitted to the base station using: the at least one RBG that fully overlaps, in the frequency domain, with the UL sub-band is used to transmit.

In example 11, which may also include one or more of the examples described herein, the UL channel resources comprise a plurality of resource block groups (RBGs), the plurality of RBGs comprising: at least one RBG that fully overlaps, in the frequency domain, with the UL sub-band, at least one RBG that partially overlaps, in the frequency domain, with the UL sub-band. and the UL information is transmitted to the base station using: the at least one RBG that fully overlaps, in the frequency domain, with the UL sub-band is used to transit. a number of PRBs, of the at least one RBG that partially overlaps, within a frequency range of the UL sub-band.

In example 12, which may also include one or more of the examples described herein, the UL channel resources comprise a plurality of resource block groups (RBGs), the plurality of RBGs comprising: at least one RBG that fully overlaps, in the frequency domain, with the UL sub-band, at least one RBG that partially overlaps, in the frequency domain, with the UL sub-band. and the UL information is transmitted to the base station using: the at least one RBG that fully overlaps, in the frequency domain, with the UL sub-band is used to transit, and the at least one RBG that partially overlaps, in the frequency domain, with the UL sub-band.

In example 13, which may also include one or more of the examples described herein, at least one precoding resource block group (PRG) is associated with the DL channel resources or the UL channel resources, and each PRG of the at least one PRG includes 2 PRBs, 4 PRBs, or wideband, and the SBFD communications involve the at least one PRG, when the at least one PRG fully overlaps, in the frequency domain, with the UL sub-band or the DL sub-band.

In example 14, which may also include one or more of the examples described herein, a plurality of precoding resource block group (PRGs) is associated with the DL channel resources or the UL channel resources, and each PRG, of the plurality of PRGs, includes 2 PRBs, 4 PRBs, or wideband, a first PRG, of the plurality of PRGs, fully overlaps, in the frequency domain, with the UL sub-band or the DL sub-band, a second PRG, of the plurality of PRGs, partially overlaps, in the frequency domain, with the UL sub-band or the DL sub-band, and the SBFD communications use all of the PRBs of the first PRG and a number of PRBs, of the second PRG, within a frequency range of the UL sub-band or the DL sub-band.

In example 15, which may also include one or more of the examples described herein, a plurality of precoding resource block group (PRGs) is associated with the DL channel resources or the UL channel resources, and each PRG, of the plurality of PRGs, includes 2 PRBs, 4 PRBs, or wideband, a first PRG, of the plurality of PRGs, fully overlaps, in the frequency domain, with the UL sub-band or the DL sub-band, a second PRG, of the plurality of PRGs, partially overlaps, in the frequency domain, with the UL sub-band or the DL sub-band, and the SBFD communications use all of the PRBs of the first PRG and the second PRG including the PRBs of the second PRG that extend beyond a frequency range of the UL sub-band or the DL sub-band.

In example 16, which may also include one or more of the examples described herein, the SBFD communications only use a slot of orthogonal frequency-division multiplexing (OFDM) symbols of the DL sub-band, when all of the OFDM symbols of the slot, of the DL sub-band, overlap with OFDM symbols of the DL channel resources, or when none of the OFDM symbols of the slot, of the DL sub-band, overlaps with OFDM symbols of the DL channel resources, and the SBFD communications only use a slot of OFDM symbols of the UL sub-band, when all of the OFDM symbols of the slot, of the UL sub-band, overlap with OFDM symbols of the UL channel resources, or when none of the OFDM symbols of the slot, of the DL sub-band, overlaps with OFDM symbols of the UL channel resources.

In example 17, which may also include one or more of the examples described herein, the SBFD communications are configured to use a slot of orthogonal frequency-division multiplexing (OFDM) symbols of the DL sub-band, when two or more of the OFDM symbols of the slot, of the DL sub-band, overlap with OFDM symbols of the DL channel resources, and the SBFD communications are configured to use a slot of OFDM symbols of the UL sub-band, when two or more of the OFDM symbols of the slot, of the UL sub-band, overlap with OFDM symbols of the UL channel resources.

In example 18, which may also include one or more of the examples described herein, when the DL channel resources and the UL channel resources, used for SBFD communications, include more than one OFDM symbols in a same slot, the DL channel resources and the UL channel resources are configured to be the same, in the frequency domain, for the OFDM symbols in the same slot.

In example 19, which may also include one or more of the examples described herein, when the DL channel resources or the UL channel resources, used for SBFD communications, include more than one OFDM symbols in a same slot, the DL channel resources and the UL channel resources are configured to be different, in the frequency domain, for the OFDM symbols in the same slot.

In example 20, which may also include one or more of the examples described herein, when DL channel resources and the UL channel resources, used for SBFD communications, are configured to use slot aggregation over more than one slot, a resulting frequency domain resource allocation, for the DL channel resources or the UL channel resources used for SBFD communications, is configured to be the same for all slots of an instance of slot aggregation.

In example 21, which may also include one or more of the examples described herein, when DL channel resources and the UL channel resources, used for SBFD communications, are configured to use slot aggregation over more than one slot, a resulting frequency domain resource allocation, for the DL channel resources or the UL channel resources used for SBFD communications, is configured to be different for different slots of an instance of slot aggregation.

In example 22, which may also include one or more of the examples described herein, the one or more processors is further configured to: determine a transport block (TB) size, for a modulation and coding scheme (MCS), after resolution of frequency domain resources when a UL channel resource partially overlaps the UL sub-band or a DL channel resource partially overlaps the DL sub-band.

In example 23, which may also include one or more of the examples described herein, the one or more processors is further configured to: determine a transport block (TB) size, for a modulation and coding scheme (MCS), based on a frequency domain allocation prior to resolution of frequency domain resources when a UL channel resource partially overlaps the UL sub-band or a DL channel resource partially overlaps the DL sub-band.

In example 24, which may also include one or more of the examples described herein, when different frequency domain resources are allocated to different slots of an instance of slot aggregation, the one or more processors is further configured to perform at least one of the following: determine a transport block (TB) size, for a modulation and coding scheme (MCS), based on a first repetition slot of the instance of slot aggregation implemented using the DL channel resources or the UL channel response; determine the TB size, for the MCS, based on a repetition slot, of the instance of slot aggregation, associated with the largest number of frequency domain resources; or determine the TB size, for the MCS, based on a repetition slot, of the instance of slot aggregation, associated with the smallest number of frequency domain resources.

In example 25, which may also include one or more of the examples described herein, when different frequency domain resources are allocated to different slots of an instance of slot aggregation, the one or more processors is further configured to: omit a repetition slot, of the instance of slot aggregation, when the repetition slot is determined to be below a threshold corresponding to at least one of: a pre-selected number of frequency domain resources; a pre-selected number of physical resource blocks (PRBs); or a pre-selected coding rate.

In example 26, which may also include one or more of the examples described herein, the SBFD communications are configured to only use a physical downlink (DL) control channel (PDCCH) monitoring occasion that overlaps with two or more SBFD symbols of the DL sub-band, when all orthogonal frequency-division multiplexing (OFDM) symbols of the PDCCH monitoring occasion overlap with SBFD symbols of the DL sub-band, or when none of the OFDM symbols of the PDCCH monitoring occasion overlap with SBFD symbols of the DL sub-bands.

In example 27, which may also include one or more of the examples described herein, when one or more resource element (RE) allocated to a DL sub-band, does not overlap with a monitored physical downlink (DL) control channel (PDCCH) candidate, or a non-overlapping control channel element (CCE) for channel estimation, the one or more processors is further configured to perform at least one of the following: process only the SBFD symbols of the DL sub-band; process the symbols of the monitored PDCCH candidate or the non-overlapping control channel elements (CCEs); or process the SBFD symbols of the DL sub-band, the monitored PDCCH candidate, and the non-overlapping CCEs in accordance with a UE capability reported to the base station indicate a capability for doing SO.

In example 28, which may also include one or more of the examples described herein,

In example 29, which may also include one or more of the examples described herein,

In example 30, which may also include one or more of the examples described herein, when the baseband processor is not configured to process a partially overlapping physical downlink (DL) control channel (PDCCH) candidate or a non-overlapping control channel element (CCE), the one or more processors is further configured to perform at least one of the following: count the monitored PDCCH candidate or the non-overlapping CCE toward a maximum number of blind decodes (BDs) or CCEs; or disregard the PDCCH candidate or the non-overlapping CCE relative to the maximum number of (BDs) or CCEs.

In example 31, which may also include one or more of the examples described herein, when PDCCH symbols overlap with SBFD symbols of a DL sub-band, and when PDCCH search spaces are linked, the one or more processors is further configured to: forego processing a pair of linked PDCCH candidates in a pair of linked search spaces that include a different number of frequency domain resources.

In example 32, which may also include one or more of the examples described herein, the SBFD communications are configured to only use a physical uplink (UL) control channel (PUCCH) resource that that overlap with two or more SBFD symbols of the UL sub-band, when all orthogonal frequency-division multiplexing (OFDM) symbols of the PUCCH resource overlap with SBFD symbols of the DL sub-band, or when none of the OFDM symbols of the PDCCH monitoring occasion overlap with SBFD symbols of the DL sub-bands.

In example 33, which may also include one or more of the examples described herein, when the UL channel resources correspond to a physical uplink (UL) control channel (PUCCH) resources, are used for SBFD communications, and are configured to use slot aggregation over more than one slot, a resulting frequency domain resource allocation of UL channel resources used for SBFD communications is configured to be one of: common for all slots of an instance of slot aggregation, or different for different slots of an instance of slot aggregation.

In example 34, which may also include one or more of the examples described herein, the one or more processors is further configured to: receive, from the base station, an uplink (UL) control indicator (UCI) and a physical uplink (UL) control channel (PUCCH) resource indicator; select a PUCCH resource set based the UCI size and a PUCCH resource using the PUCCH resource indicator; and when a number of frequency domain resources allocated to the UL sub-band for SBFD communications is below a corresponding threshold, select a next PUCCH resource set corresponding to a larger UCI size; and select another PUCCH resource using the PUCCH resource indicator, wherein the corresponding threshold is based on at least one of the following: a pre-selected number of frequency domain resources; a pre-selected number of physical resource blocks (PRBs); or a pre-selected coding rate.

In example 35, which may also include one or more of the examples described herein, a frequency range comprises a plurality of contiguous sub-bands, each sub-band of the plurality of contiguous sub-bands comprises a plurality of contiguous physical resource blocks (PRBs), and the one or more processors is further configured to: receive channel state information (CSI) measurement configuration information comprising instructions for performing a CSI measurement for at least one sub-band, of the plurality of contiguous sub-bands; and perform the CSI measurement on the at least one sub-band; and cause the CSI measurement to be reported to the base station.

In example 36, which may also include one or more of the examples described herein, the at least one sub-band of the plurality of contiguous sub-bands comprises at least one of: a sub-band that fully overlaps with the DL sub-band; a sub-band that partially overlaps with the DL sub-band; or a sub-band with a number of PRBs, above a PRB threshold, which overlap with the DL sub-band, wherein the PRB threshold comprises a pre-selected number of PRBs.

In example 37, which may also include one or more of the examples described herein, frequency domain (FD) orthogonal cover code (OCC) 4 (FD-OCC4) is used for physical downlink (DL) shared channel (PDSCH) demodulation reference signals (DMRS), or physical uplink (UL) shared channel (PUSCH) demodulation reference signals (DMRS), with cyclic prefix (CP) OFDM (CP-OFDM) waveform and a type 1 DMRS configuration, and when an orphaned code-division multiplexing (CDM) group occurs, such that a CDM group spans two consecutive physical resource blocks (PRBs), and one PRB overlaps with the DL sub-band, the resource allocation information includes instructions for reference signal measurement and reporting such that: a lowest PRB of the DL sub-band having an even number of physical resource blocks PRBs to a common resource block 0; a highest PRB of the DL sub-band having an even number of PRBs to the selected point A; or the DL sub-band has an event number of PRBs.

In example 38, which may also include one or more of the examples described herein, frequency domain (FD) orthogonal cover code (OCC) 4 (FD-OCC4) is used for physical downlink (DL) shared channel (PDSCH) demodulation reference signals (DMRS), or physical uplink (UL) shared channel (PUSCH) demodulation reference signals (DMRS), with cyclic prefix (CP) OFDM (CP-OFDM) waveform and a type 1 DMRS configuration, and when an orphaned code-division multiplexing (CDM) group occurs, such that a CDM group spans two consecutive physical resource blocks (PRBs), and one PRB overlaps with the DL sub-band, the resource allocation information includes instructions for reference signal measurement and reporting such that: only a PRB that overlaps with the DL sub-band is used for reference signal measurement; PRBs that fully overlap with the DL sub-band and PRBs that partially overlap with the DL sub-band are used for reference signal measurement; or reference signal measurement involves neither PRBs that fully overlap with the DL sub-band nor PRBs that partially overlap with the DL sub-band.

In example 39, which may also include one or more of the examples described herein, a user equipment (UE) may comprise: a memory; and one or more processors configured to, when executing instructions stored in the memory, cause the one or more processors to: receive, from a base station, resource allocation information for communicating with the base station via sub-band full-duplex (SBFD) communications, the resource allocation information comprising: downlink (DL) channel resources that overlap, in a frequency domain, with a DL sub-band associated with the SBFD communications; and uplink (UL) channel resources that overlap, in the frequency domain, with a UL sub-band associated with the SBFD communications; generate UL information to be communicated to the base station; and engage in SBFD communication by: transmitting, via the UL channel resources that overlap in the frequency domain with the UL sub-band, the UL information as part of the SBFD communications; and receiving, via the DL channel resources that overlap with the DL sub-band, DL information as part of the SBFD communications.

In example 40, which may also include one or more of the examples described herein, a base station may comprise: radio frequency circuitry; a memory; and one or more processors configured to, when executing instructions stored in the memory, cause the one or more processors to: receive, from a user equipment (UE), UE capability information that includes an indication of an ability of the UE to engage in sub-band full-duplex (SBFD) communications; determine, based on the UE capability information, resource allocation information for SBFD communications between the base station and the UE, the resource allocation information comprising: downlink (DL) channel resources that overlap, in a frequency domain, with a DL sub-band associated with the SBFD communications; and uplink (UL) channel resources that overlap, in the frequency domain, with a UL sub-band associated with the SBFD communications; generate DL information to be communicated to the UE; and cause the RF circuitry to engage in SBFD communication by: transmitting, via the DL channel resources that overlap in the frequency domain with the UL sub-band, the DL information as part of the SBFD communications; and receiving, via the UL channel resources that overlap with the UL sub-band, UL information as part of the SBFD communications.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A baseband processor, comprising:
a memory; and
one or more processors configured to, when executing instructions stored in the memory, cause the baseband processor to:
receive, from a base station, resource allocation information for communicating with the base station via sub-band full-duplex (SBFD) communications, the resource allocation information comprising:
downlink (DL) channel resources that overlap, in a frequency domain, with a DL sub-band associated with the SBFD communications; and
uplink (UL) channel resources that overlap, in the frequency domain, with a UL sub-band associated with the SBFD communications;
generate UL information to be communicated to the base station; and
cause the RF circuitry to engage in SBFD communication by:
transmitting, via the UL channel resources that overlap in the frequency domain with the UL sub-band, the UL information as part of the SBFD communications; and
receiving, via the DL channel resources that overlap with the DL sub-band, DL information as part of the SBFD communications.

2. The baseband processor of claim 1, wherein the baseband processor is part of a user equipment (UE).

3. The baseband processor of claim 1, wherein the one or more processors are further configured to:
generate UE capability information indicating an ability of UE to engage in SBFD communications; and
communicate the UE capability to the base station,
wherein the resource allocation information, received from the base station, is based on the UE capability information.

4. The baseband processor of claim 1, wherein:
the UL channel resources partially overlaps with the UL sub-band and the physical resource blocks (PRBs) of the partially overlapping portion of the UL channel resources are used to transmit the UL information; and
the DL channel resources partially overlaps with the DL sub-band and the PRBs of the partially overlapping portion of the DL channel resources are used to receive the DL information.

5. The baseband processor of claim 1, wherein:
a frequency range of the DL channel resources is greater than a frequency range of the DL sub-band,
a frequency range of the UL channel resources is greater than a frequency range of the UL sub-band, and
a first gap, in the frequency domain, between the DL sub-band and the UL sub-band is the same as a second gap, in the frequency domain, between the DL channel resources that overlap with the DL sub-band and the UL resources that overlap with the UL sub-band.

6. The baseband processor of claim 1, wherein:
the UL channel resources that overlap with the UL sub-band comprise a number of PRBs that is less than a total number of PRBs of the UL channel resources and less than or equal to the total number of PRBs of the UL sub-band, and
the DL channel resources that overlap with the DL sub-band comprise a number of PRBs that is less than a total number of PRBs of the DL channel resources and less than or equal to the total number of PRBs of the DL sub-band.

7. The baseband processor of claim 1, wherein the resource allocation information comprises a type 1 frequency domain resource allocation that includes a resource indication value (RIV) corresponding to a starting PRB and a length of contiguously allocated PRBs.

8. The baseband processor of claim 1, wherein:
the DL channel resources comprise at least one of:
a physical DL shared channel (PDSCH), or
a physical DL control channel (PDCCH), and
the UL channel resources comprise at least one of:
a physical UL shared channel (PUSCH); or
a physical UL control channel (PDCCH).

9. The baseband processor of claim 1, wherein the resource allocation information comprise a type 0 domain resource allocation include a bitmap indicating a resource allocation of at least one resource block group (RBG) to the DL channel or the UL channel, each RBG of the at least one RBG comprising a number of contiguous PRBs.

10. The baseband processor of claim 1, wherein:
the UL channel resources comprise a plurality of resource block groups (RBGs), the plurality of RBGs comprising:
at least one RBG that fully overlaps, in the frequency domain, with the UL sub-band,
at least one RBG that partially overlaps, in the frequency domain, with the UL sub-band, and
the UL information is transmitted to the base station using:
the at least one RBG that fully overlaps, in the frequency domain, with the UL sub-band is used to transmit.

11. The baseband processor of claim 1, wherein:
the UL channel resources comprise a plurality of resource block groups (RBGs), the plurality of RBGs comprising:
at least one RBG that fully overlaps, in the frequency domain, with the UL sub-band,
at least one RBG that partially overlaps, in the frequency domain, with the UL sub-band, and
the UL information is transmitted to the base station using:
the at least one RBG that fully overlaps, in the frequency domain, with the UL sub-band is used to transit,
a number of PRBs, of the at least one RBG that partially overlaps, within a frequency range of the UL sub-band.

12. The baseband processor of claim 1, wherein:
the UL channel resources comprise a plurality of resource block groups (RBGs), the plurality of RBGs comprising:
at least one RBG that fully overlaps, in the frequency domain, with the UL sub-band,
at least one RBG that partially overlaps, in the frequency domain, with the UL sub-band, and
the UL information is transmitted to the base station using:
the at least one RBG that fully overlaps, in the frequency domain, with the UL sub-band is used to transit, and
the at least one RBG that partially overlaps, in the frequency domain, with the UL sub-band.

13. The baseband processor of claim 1, wherein:
at least one precoding resource block group (PRG) is associated with the DL channel resources or the UL channel resources, and each PRG of the at least one PRG includes 2 PRBs, 4 PRBs, or wideband, and
the SBFD communications involve the at least one PRG, when the at least one PRG fully overlaps, in the frequency domain, with the UL sub-band or the DL sub-band.

14. The baseband processor of claim 1, wherein:
a plurality of precoding resource block group (PRGs) is associated with the DL channel resources or the UL channel resources, and each PRG, of the plurality of PRGs, includes 2 PRBs, 4 PRBs, or wideband,
a first PRG, of the plurality of PRGs, fully overlaps, in the frequency domain, with the UL sub-band or the DL sub-band,
a second PRG, of the plurality of PRGs, partially overlaps, in the frequency domain, with the UL sub-band or the DL sub-band, and
the SBFD communications use all of the PRBs of the first PRG and a number of PRBs, of the second PRG, within a frequency range of the UL sub-band or the DL sub-band.

15. The baseband processor of claim 1, wherein:
a plurality of precoding resource block group (PRGs) is associated with the DL channel resources or the UL channel resources, and each PRG, of the plurality of PRGs, includes 2 PRBs, 4 PRBs, or wideband,
a first PRG, of the plurality of PRGs, fully overlaps, in the frequency domain, with the UL sub-band or the DL sub-band,
a second PRG, of the plurality of PRGs, partially overlaps, in the frequency domain, with the UL sub-band or the DL sub-band, and
the SBFD communications use all of the PRBs of the first PRG and the second PRG including the PRBs of the second PRG that extend beyond a frequency range of the UL sub-band or the DL sub-band.

16. The baseband processor of claim 1, wherein:
the SBFD communications only use a slot of orthogonal frequency-division multiplexing (OFDM) symbols of the DL sub-band,
when all of the OFDM symbols of the slot, of the DL sub-band, overlap with OFDM symbols of the DL channel resources, or
when none of the OFDM symbols of the slot, of the DL sub-band, overlaps with OFDM symbols of the DL channel resources, and
the SBFD communications only use a slot of OFDM symbols of the UL sub-band,
when all of the OFDM symbols of the slot, of the UL sub-band, overlap with OFDM symbols of the UL channel resources, or
when none of the OFDM symbols of the slot, of the DL sub-band, overlaps with OFDM symbols of the UL channel resources.

17. A user equipment (UE), comprising:
a memory; and
one or more processors configured to, when executing instructions stored in the memory, cause the UE to:
receive, from a base station, resource allocation information for communicating with the base station via sub-band full-duplex (SBFD) communications, the resource allocation information comprising:
downlink (DL) channel resources that overlap, in a frequency domain, with a DL sub-band associated with the SBFD communications; and
uplink (UL) channel resources that overlap, in the frequency domain, with a UL sub-band associated with the SBFD communications;
generate UL information to be communicated to the base station; and
engage in SBFD communication by:
transmitting, via the UL channel resources that overlap in the frequency domain with the UL sub-band, the UL information as part of the SBFD communications; and
receiving, via the DL channel resources that overlap with the DL sub-band, DL information as part of the SBFD communications.

18. The UE of claim 1, wherein:
the SBFD communications only use a slot of orthogonal frequency-division multiplexing (OFDM) symbols of the DL sub-band,
when all of the OFDM symbols of the slot, of the DL sub-band, overlap with OFDM symbols of the DL channel resources, or
when none of the OFDM symbols of the slot, of the DL sub-band, overlaps with OFDM symbols of the DL channel resources, and
the SBFD communications only use a slot of OFDM symbols of the UL sub-band,
when all of the OFDM symbols of the slot, of the UL sub-band, overlap with OFDM symbols of the UL channel resources, or
when none of the OFDM symbols of the slot, of the DL sub-band, overlaps with OFDM symbols of the UL channel resources.

19. A base station, comprising:
radio frequency circuitry;
a memory; and
one or more processors configured to, when executing instructions stored in the memory, cause the one or more processors to:
receive, from a user equipment (UE), UE capability information that includes an indication of an ability of the UE to engage in sub-band full-duplex (SBFD) communications;
determine, based on the UE capability information, resource allocation information for SBFD communications between the base station and the UE, the resource allocation information comprising:
downlink (DL) channel resources that overlap, in a frequency domain, with a DL sub-band associated with the SBFD communications; and
uplink (UL) channel resources that overlap, in the frequency domain, with a UL sub-band associated with the SBFD communications;
generate DL information to be communicated to the UE; and
cause the RF circuitry to engage in SBFD communication by:
transmitting, via the DL channel resources that overlap in the frequency domain with the UL sub-band, the DL information as part of the SBFD communications; and
receiving, via the UL channel resources that overlap with the UL sub-band, UL information as part of the SBFD communications.

20. The base station of claim 19, wherein:
a frequency range of the DL channel resources is greater than a frequency range of the DL sub-band,
a frequency range of the UL channel resources is greater than a frequency range of the UL sub-band, and
a first gap, in the frequency domain, between the DL sub-band and the UL sub-band is the same as a second gap, in the frequency domain, between the DL channel resources that overlap with the DL sub-band and the UL resources that overlap with the UL sub-band.
